(19) United States
(12) Patent Application Publication
(10) Pub. No.: US 2008/0254170 A1
(43) Pub. Date: Oct. 16, 2008

(54) MULTI-COMPARTMENT PRODUCE CONTAINER WITH CONTROLLED GAS PERMEATION

(76) Inventor: Neil Edward Darin, Grayslake, IL (US)

Correspondence Address: FITCH EVEN TABIN & FLANNERY, 120 S. LASALLE STREET, SUITE 1600, CHICAGO, IL, 60603-3406, US

(21) Appl. No.: 11/734,627

(22) Filed: Apr. 12, 2007

(51) Int. Cl. B65D 81/20; A23B 7/144; B65D 85/30

(52) U.S. Cl. 426/118

(57) ABSTRACT

A multi-component produce container providing controlled gas transmission to a produce product stored within is disclosed. A base stores the produce therein and is sealed with an oxygen permeable film layer. A lid comprising multiple compartments for storing food ingredients therein for addition to the produce product has a barrier film layer over openings in the compartments. The lid further comprises air channels positioned through a rim of the lid. While the container is in the closed configuration, an air cavity is present between the base and lid. The air channels together with the air cavity allow air to exchange from outside the closed container, into the air cavity between the base and lid, and thus into the base through the oxygen permeable film.

### FIELD

A multi-compartment container for separation of food ingredients from produce, and in particular a multi-compartment container for providing controlled gas migration between the outside atmosphere and the produce.

### BACKGROUND

It is common practice in the fresh cut produce industry to control gas transmission into and out of packaging. To extend the shelf life of fresh produce, the oxygen, carbon dioxide, and ethylene surrounding the produce are controlled. In the current bagged lettuce industry, low residual oxygen levels can be achieved by combining modified atmosphere packaging (“MAP”) techniques and high oxygen transmission rate plastic films. MAP techniques can be used to reduce the overall oxygen level by modifying the internal atmosphere of the package and high oxygen transmission rate plastic films can be used to allow a controlled rate of oxygen into the sealed package over the shelf life of the product. Oxygen is used by the lettuce to make carbon dioxide and over time the oxygen levels are depleted, which is why migration of oxygen into the outer package can keep the produce fresh. This method has enabled the shelf life of cut lettuce to be extended up to 17 days when held at ideal temperatures. In the case of some produce, like spinach, a perforated plastic film is used without modifying the atmosphere to promote gas exchange into and out of the sealed package. The microscopic perforations in the film allow gas to exchange between the inside and outside of a sealed produce package; these microscopic perforations are currently used on fresh produce bags today.

Additionally, it is also desirable to sell fresh cut lettuce in a portable, disposable container that a consumer can also use as a serving container. Several rigid plastic containers have been developed to meet this consumer need. However, rigid plastic containers are often made from plastics that have a very low oxygen transmission rate that is not ideally suitable for produce. Some containers have reclosable lids that can be used to store left over product for a short period of time, and simplify preparation of a salad. Additionally, salad dressing can be poured onto the produce, the lid reclosed, and the closed containers shaken to help disperse the dressing in the produce. Rigid plastic lids have been designed with snap fit rims for this purpose. Unfortunately, rigid plastic lids have a very low oxygen transmission rate when compared with the flexible film bags used to contain produce, thereby making it difficult to achieve sufficient shelf life for fresh cut lettuce. In some rigid containers, the produce compartment is covered with the perforated plastic film. However, if this plastic film is covered with a rigid plastic lid, the benefit of oxygen migration can be lost and a shortened shelf life can result because the produce can become starved of oxygen and spoil since the oxygen cannot sufficiently pass into the produce compartment.

It is often desired to have ready made salads or meals already prepared for consumption by consumers within its package. Fresh cut lettuce may be mixed with various salad condiments such as croutons, cheese, or meat. However, these ingredients have different shelf-life requirements that may not be sufficiently met when packaged together in the same compartment with the produce. For instance, protein, cheese and croutons do not need additional oxygen as compared to produce, and if they do receive additional oxygen they can spoil and/or become soggy, which can yield an unpleasant appearance and mouthfeel. Further, separation of components can prevent product moisture from migrating between dry and wet ingredients. If moisture migration occurs, shelf life of both dry and wet ingredients can be greatly reduced.

One solution has been to provide multi-compartment packages to separate the various salad ingredients from the produce, such that a lower compartment contains the produce and an upper lid contains a divided compartment for the various food ingredients. If the lid is placed over the produce compartment, it can block oxygen access to the produce and the produce becomes starved of oxygen, as discussed above.

Another solution provided by currently available retail products is to have a multi-cavity tray of ingredients that sits inside a bowl of lettuce. The combined package is then flushed and sealed in a MAP operation. However, one oxygen level and gas mix is often used for the entire package consisting of both the produce and the ingredients inside the multi-cavity tray. The problem with this combined packaging system is that each food product component requires varying levels of oxygen to maintain the product shelf-life. For example, produce can be packaged into an environment containing about 2-4% oxygen. For some oxygen sensitive ingredients such as meats, on the other hand, the oxygen level desired is less than about 1%. Produce packaged at less than about 1% oxygen levels will degrade faster, developing off odors and flavors, because there is insufficient oxygen for respiration. However, meat packaged at higher than about 1% oxygen levels can have a reduced shelf-life. Furthermore, it is also desirable to extend the shelf life of some ingredients by using carbon dioxide in the gas flush stage of the modified atmosphere operation. Carbon dioxide, however, can be detrimental to the flavor quality of produce, therefore a full nitrogen flush is preferred. Therefore, packaging systems of this type require a compromise in the gas levels where the oxygen level and gas flush mix chosen may not always deliver the highest quality, longest shelf-life product.

Another variation may be where a multi-cavity tray is filled with ingredients and sealed utilizing a MAP operation that is then placed inside a bowl of lettuce, i.e., on top of the lettuce, and sealed a second time using a MAP operation. In this instance, the multi-cavity tray is in contact with the produce, i.e., resting on top of it, which is often not desirable by consumers to have the packaging materials in contact with the produce. Consumer concerns are related to the multi-cavity tray crushing or bruising the sensitive produce and the perceived cleanliness of the packaging materials in contact with it. The weight of the filled multi-cavity tray can also damage the produce during distribution. The tray can also inhibit oxygen exchange from the outside environment to the produce by acting as a partial barrier.

Produce and food products that are packaged using MAP operations can contain a head space filled with gas which can experience seal breakage when transported over high altitudes. As altitude increases, the gas in the head space of a sealed container expands creating an increase of internal pressure which can be seen as a pillowing effect in the film seal overlay. If the material expands too much, the increased pressure can compromise the seals of the container causing them to break and leak. In the case of a modified atmosphere package, the leak will result in a significantly shorter shelf life.

### SUMMARY

A produce container, such as a multi-component produce container, is provided to permit gas transmission when a lid is placed over the produce container, while delivering the convenience of a reclosable lid. The rigid base of the container is sealed with a higher oxygen transmission rate film appropriate to cut produce stored therein. A rigid lid snaps over a seal flange of the base container to provide a re-close feature. When the lid is on the base, an air cavity exists between the film of the base and the lid. Vents allow oxygen from outside the closed container to enter the air cavity between the film of the base and lid, and thus through the film into the produce container.

The produce is separated from other optional ingredients during storage and handling. These separated ingredients can then be combined by the consumer at the time of consumption. The design of the multi-component produce container allows for separation of the produce (i.e., stored in a base) from other ingredients (by storing the other components in the lid). Further, each of the other ingredients can be contained in an individually sealed package or directly filled into independently sealable packaging cavities. The base and lid can be conveniently combined to be sold as an individual complete unit.

The produce container enables two different gas mixtures to accommodate the varying atmospheric requirements of the package components, such that the produce and other optional food ingredients can be packaged separately in the base and lid, respectively, with different gas mixtures suitable for the different foods.

The packaging components can be individually sealed. For instance, multi-compartment cavities within the lid can be individually sealed, such as with a film, to prevent product migration during shipment. This can ensure the outside of the packaging is not in contact with the produce and the weight of other packaging components is not resting on the produce. Furthermore, the lid contains a re-close feature so that consumers can control how much product they eat at a sitting and can save the remaining food portion for another time. A re-close feature has other benefits as well. For salads and other meals that contain a sauce or dressing, a consumer may have the desire to pour the salad dressing or sauce over the ingredients, close the container, and shake the container to disperse the dressing or sauce. In the multi-component produce container, the container allows consumers to maintain the product separation until consumption, provides a convenient way to mix ingredients when necessary by closing the lid and shaking without spilling the ingredients, and to save unconsumed portions of their snack or meal by reclosing the container.

Rigid plastic packaging is generally not desirable for produce that requires high gas exchange, since rigid plastic packaging does not have a gas exchange rate high enough to satisfy the requirements of these types of produce causing the produce to have a significantly reduced shelf life. Therefore, a combination of air channels in the lid and an air cavity between the base and lid was created to allow a high exchange of gas through the flexible plastic film and into the base. The channels in the snap-fit lid and the air cavity allow gases to flow freely through the perforated film or high gas transmission film covering the produce and into the produce container. The amount of gas exchange can be controlled by the size and number of perforations in the film, or the film can have a property that allows for high gas transmission through the material.

Additionally, the produce container is adapted to remain sealed, with the lid and base together, in high altitudes exceeding 8,000 feet. This can be accomplished by controlling the atmospheric pressure within the sealed package during the MAP operation. In addition, the air cavity between the lid and bowl allows for some gas expansion within the package without causing the lid to separate from the bowl or a leak to form.

### BRIEF DESCRIPTION OF THE DRAWINGS

FIG. 1 is a perspective view of a multi-compartment lid of a multi-component produce container;

FIG. 2 is a perspective view of a base of the multi-component produce container;

FIG. 3 is a top plan view of the multi-component container with the lid of FIG. 1 assembled with the base of FIG. 2;

FIG. 4 is a cross-sectional view taken along line 4-4 of FIG. 3 and showing a vent passage;

FIG. 5 is a cross-sectional view taken along line 5-5 of FIG. 3;

FIG. 6 is a cross-sectional view taken along line 6-6 of FIG. 3;

FIG. 7 is a bottom plan view of the multi-component container of FIG. 3 showing in phantom a surrounding band;

FIG. 8 is a side elevation view of an assembled multi-component container showing the band; and

FIG. 9 is a process line schematic of a method of manufacturing the container.

### DETAILED DESCRIPTION

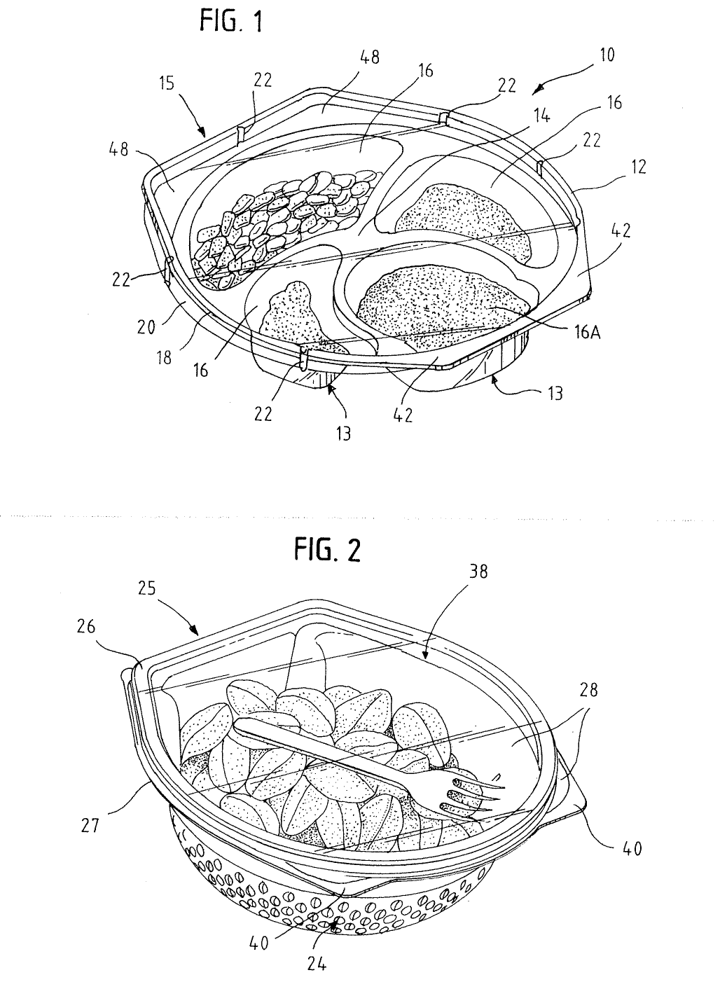

A produce container and, in particular, a multi-compartment produce container adapted for gas permeation between a produce compartment and the outside atmosphere while maintaining gas levels in other compartments of the container, and methods of manufacture thereof, are disclosed herein and illustrated in FIGS. 1-9. In particular, the multi-compartment produce container separates different food components from one another and allows oxygen migration from the atmosphere outside of the container into the produce compartment when covered by a lid.

The produce is contained in a rigid base or bowl section that has an opening covered by an oxygen permeable film. A rigid lid is placed over the sealed opening of the bowl section. The lid contains additional food ingredients and salad condiments in various recessed food compartments thereof. The compartments are sealed with a barrier film to prevent the ingredients from migrating out of their respective individual compartments and to prevent oxygen from entering the compartments. Once the lid is placed on the bowl section, a rim of the lid can snap into place over a flange of the bowl to fixedly attach the lid to the bowl in an assembled configuration until forcibly removed apart. The rim of the lid contains one or more air channels or vents that allow oxygen to pass therethrough and enter an air cavity between the film sealing the bowl and film sealing the lid while the container is in the assembled configuration. Once the oxygen enters the air cavity it can pass through the oxygen permeable film placed over the bowl, but not through the barrier film over the lid. The oxygen passes through the oxygen permeable film as needed to replenish the oxygen level of the produce, to maintain the produce in a fresh state, and to preserve shelf-stability. The barrier film placed over the food ingredients of the lid prevents additional oxygen from passing through the sealed lid and therefore also maintains the freshness of those food ingredients by maintaining the oxygen at low levels necessary to maintain the freshness and shelf stability of the food ingredients and condiments.

Additionally, the vent channels further provide for a more stable package when transporting over high altitudes exceeding at least 4,000 feet, and more preferably at least 8,000 feet, such that the lid and bowl do not separate due to pressure increases therebetween and the film seals over each do not separate. Separation is prevented by allowing some space for expansion within the air cavity between the bowl and the lid. Preferably, the outer film band placed over the lid and bowl can prevent separation at altitudes in excess of at least 12,000 feet.

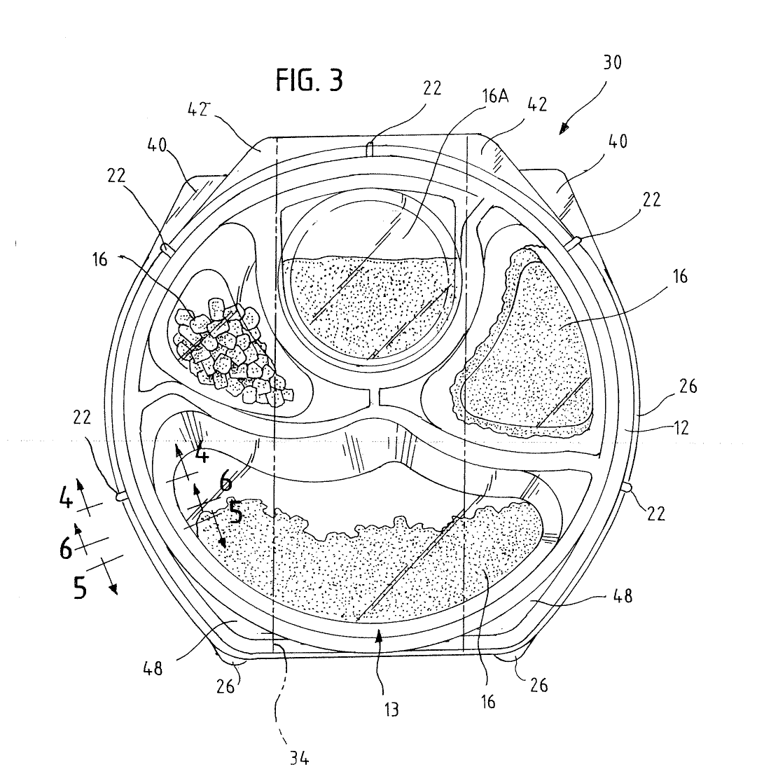

A multi-compartment produce container 30, as shown from a top view in FIG. 3, is provided in the assembled configuration where the rigid lid 10 is placed over the base 24 to close the container 30, after both components have been separately sealed. The lid 10 may be sealed with a barrier film 14 that prevents migration of oxygen therethrough, and the base 24 may be sealed with an oxygen permeable film 28 that allows oxygen to enter. Optionally, a label 34, or band, may be placed around the sealed container 30 to designate a product name and/or nutritional information, and may assist in keeping the lid 10 snapped in place over the base 24. When viewed in the assembled configuration and looking down at the top, a backside (i.e., outer side) of a number of lid compartments 16 and 16A may be visible.

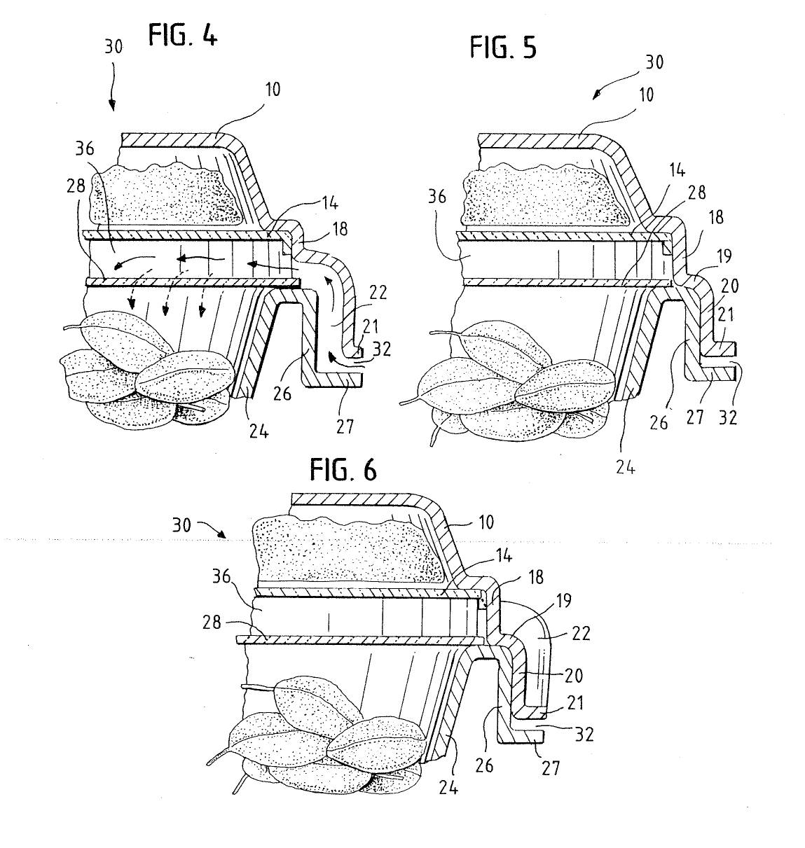

The outer perimeter of the lid 10 is defined by a rim 12 and the base 24 is similarly defined by a flange 26 about its perimeter. Positioned along the rim 12 are at least one or more air channels or vents 22. These air channels 22 are located along the rim 12 of the lid 10, which allow air to enter therethrough when placed over the flange 26 in the base 24. As shown in FIG. 4, the air channel 22 can be a small passage positioned in the rim 12 of the lid 10 such that oxygen from the atmosphere outside of the package 30 can enter, first through a gap 32 between the rim 12 and the flange 26, and then through the channel 22 towards an air cavity 36 located between the lid 10 and the base 24. The vent channels 22 provide an alternate way to provide oxygen to the film 28 and the produce within when the lid 10 is placed over the base 24 physically blocking direct access to the oxygen permeable film 28 over the base 24 from the outside air.

In the assembled and closed configuration, the air cavity 36 of the container 30 can be located between a top surface of the base 24 and a bottom surface of the lid 10, such that the air cavity 36 is bounded by the oxygen permeable film 28 on the bottom and the barrier film 14 over the lid 10 on the top, when the container 30 is placed flat on the bottom side of the base 24, as shown in FIGS. 3 and 8.

Furthermore, the rim 12 can comprise at least two vertical segments 18 and 20 that make up a stepped portion or ledge around the lid 10 perimeter. The gap 32 can be positioned all around the perimeter of the container 30, between the bottom of a second horizontal rim 21 of the lid 10 and a horizontal portion 27 of the flange 26, where the gap 32 first allows the air to enter. After entering through the gap 32 the air can then travel through the air channel 22, if one is present. The package 30, as shown in FIG. 3, contains six air channels 22. The arrows in FIG. 4 indicate the path of travel of the air through the gap 32, into the channel 22, then into the air cavity 36 and finally through the oxygen permeable film 28.

There may be at least one air channel 22 in the rim 12 and, preferably, there are six equidistantly spaced air channels 22, but any appropriate number can be used. The air vents 22 of the present example are small, typically at least about 1 mm wide and at least about the same or greater in length. The air channel 22 can protrude slightly out from the edge of the rim 12.

FIG. 5 illustrates a cross-sectional view of the rim 12 of the lid 10 and the flange 26 on the base 24 at a location on the rim 12 where there is no vent. The rim 12 of the lid 10 and the flange 26 around the base 24 sit relatively flush with one another and generally can create a seal therebetween, except at the lower horizontal segments 21 and 27. The seal may or may not be hermetic. The lower horizontal segments 21 and 27 are spaced apart slightly to form the gap 32 which allows air to enter therein. Where there is no vent, the air may enter the gap 32, but goes no further. FIG. 6 also illustrates a part of the rim 12 and flange 26 where there is no vent, however, an adjacent vent 22 can be seen in the background slightly protruding from the outer surface of the rim 12. In contrast, where there is a vent 22, as in FIG. 4, the air enters through the gap 32 and then continues up through the vent 22 and into the air cavity 36.

When the produce container 30 is in the assembled configuration, the lid 10 is placed over the base 24 such that the lid 10 is turned upside down with its film 14 sealed openings positioned towards a bottom direction and facing the top of the base 24 and its film 28 sealed opening. The flange 26 of the base 24 can have a flat rim that surrounds the perimeter of the base 24 and surrounds the opening 38. The rim 12 of the lid 10 and the flange 26 of the base 24 are brought together such that a surface 15 on the lid 10 is matched up with a surface 25 of the base 24. The rim 12 of the lid 10 can snap in place over the flange 26 of the base 24, securing the lid 10 to the base 24, and where the lid 10 can only be removed by forcibly removing the lid 10 from the base 24. When the lid 10 is placed on top of the base 24, the rim 12 overlays the flange 26 of the base 24 such that the two compliment each other.

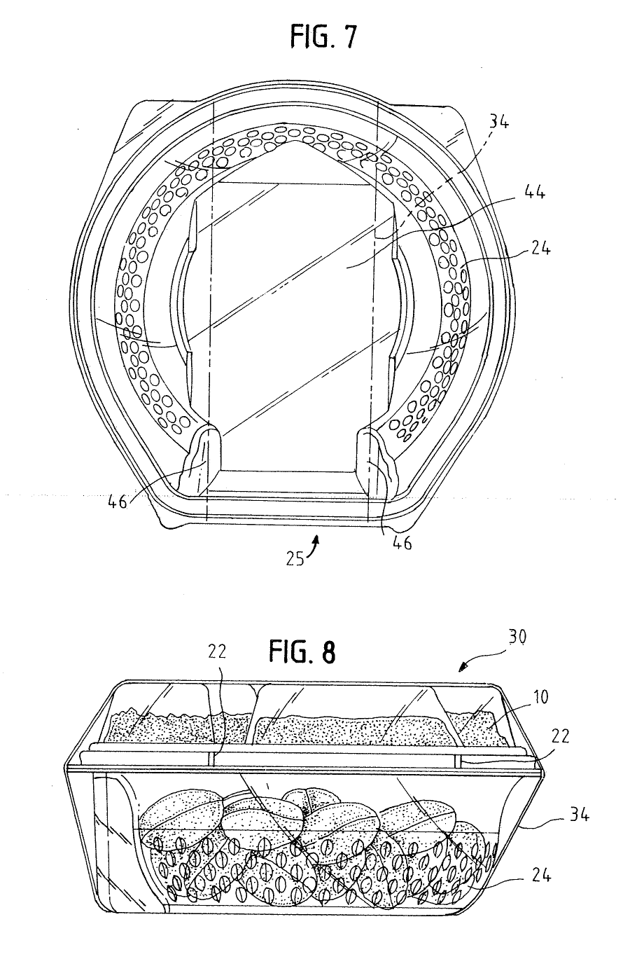

When the lid 10 and base 24 components are separated, as shown in FIGS. 1 and 2, each component can contain a film seal over its respective opening therein. The bowl, or base 24, as shown in FIG. 2, has a single compartment and is made of a rigid material for storing produce therein. The base 24 has a generally circular shape, and typically more of a horseshoe shape, such that the majority of the base 24 is generally round with a small section having a configuration similar to a chord of a circle. This can be used to stand the base 24 up on its side for display purposes or for storage. On the outside of the base 24 are two feet 46 that provide support to stand the container up on its edge or side. The feet 46 are part of a concave section around the base 24. The outer side edges of the base 24 form the concave section, having a bowl-like shape, that also has a flat bottom, and the outer side edges may be smooth or contain ridges or decorations thereon, or a combination of both. The bottom 44 of the base 24, as shown in FIG. 7, is generally flat and likewise can be used to support the container for display or storage purposes on its bottom side 44.

The flange 26 around the base 24 can further drop down vertically along the outside of the base 24 at least about ½ mm, until intersecting a horizontal section or ledge 27. The ledge 27 generally follows the shape of the flange 26 and protrudes out, away from an outer side edge of the base 24, by at least about ½ mm, but may be greater in certain sections of the ledge 27. At least one section of the ledge 27 may have a protrusion or corner 40 that forms a tab to aid in separating the base 24 from the lid 10 when in the assembled configuration, and which may protrude out away from the outer side edge of the base 24 by a few millimeters. Preferably, two tabs or corners 40 will be positioned on a similar arc of a circular segment of the base 24 to aid in opening. A further use of the tabs 40 along the flange 26 may be to provide an overlap point for a film seal 28 placed over the opening 38 at which to grasp the film 28 and pull it to remove it from the opening 38. The film 28 used to seal the opening 38 over the base 24 can be the oxygen permeable film 28. Such oxygen permeable film layers may comprise films made of polypropylene and low density polyethylene. The film 28 can seal the produce in the base 24 and can allow a path for transmission of oxygen gas through the film 28 and into the base 24 to provide oxygen to the produce to help maintain its freshness.

The rim 12 of the lid 10 also may have a horizontal protrusion or corner tabs 42 that are part of the second horizontal rim 21 and may overlap a portion of the tabs 40 in the base 24 when the two are assembled. The tabs 42 in the lid 10 can be slightly smaller than the tabs 40 in the base 24 so that a portion of each tab 42 can be easily grasped to make pulling the lid 10 apart from the base 24 easier. Alternatively, the converse may also be true, where the tabs 42 in the lid 10 can be slightly larger than the tabs 40 in the base 24. The second horizontal rim portion 21 extends at least about ½ mm around the lid 10 and is greater at the location of the lid corner tabs 42. Additionally, opposite the location of the corner tabs 42 the second horizontal rim section 21 may also extend past the rim 12 to form small corner tabs 48, located adjacent the surface 15 of the lid 10.

The lid 10 can comprise an upper surface, which can contain several openings, and a lower surface, which is opposite the openings and is visible when the container 30 is in the closed configuration. The lid 10 further can be reclosable, thereby reducing the drawbacks associated with non-reclosable food containers.

The upper surface of the lid 10 can comprise a smooth flat section and openings formed therein by recessed compartments 16 and 16A. The lid 10 may contain at least two compartments 16, preferably at least three and still more preferably four. One compartment 16A may be used to hold a dressing cup and the remaining compartments 16 may contain a protein source or various other salad condiments. The barrier film 14 may be placed over each compartment 16 and 16A, and preferably a single sheet of barrier film is placed over the entire tray 10 and sealed under negative pressure, such that each compartment 16 and 16A of the tray 10 becomes individually sealed. A seal over each compartment 16 and 16A can keep the food components segregated within their respective compartment 16 and 16A and can prevent food migration or intermingling between the compartments 16 and 16A due to the seal 14 being slightly recessed into the compartments 16 and 16A.

When the lid 10 is positioned in its closed, assembled state (i.e., such that the lid 10 is placed upside down onto the base 24), a first vertical segment 18 can define a generally circular area having a height of at least about ½ mm around the multiple food compartments, which corresponds to the height of the air cavity 36. At a lower end of the first vertical segment 18 may be a first horizontal rim portion 19, which is a radially outwardly extending segment, that may transform into a second vertical segment 20, such as a depending segment from the first horizontal rim portion 19, at an area where the rim 12 intersects with the flange 26 of the base 24 when assembled. The second vertical segment 20 of the lid 10 is shaped such that it compliments the shape of the flange 26 of the base 24 when placed on top of the base 24 in its assembled configuration. The second vertical segment 20 extends downwards at least about 1 mm to 2 mm and ends in a second horizontal rim portion 21. The first horizontal section 19 lays generally flush with a horizontal section of the flange 26 and the second vertical segment 20 of the rim 12 lays generally flush with the vertical section of the flange 26. The only portion that does not lie generally flush is the second horizontal section 21 of the rim 12 and the respective horizontal ledge 27 of the flange 26. These two sections can be slightly spaced apart to provide the opening or gap 32, at least about ½ mm for example, all the way around the container 30. The gap 32 allows oxygen to pass between the rim 12 and flange 36.

The lid compartments 16 and 16A may be configured in any shape and orientation to contain the food product, and preferably there will be four compartments. The compartments 16 and 16A can be comprised of a recess or cavity in the lid such that the majority of the recess can sit below the upper lid surface, when positioned with the openings of the recess accessible from the top, as shown in FIG. 1. Since there is at least one dressing cup, at least one of the lid compartments 16A may be generally circular in shape to house the dressing cup. Preferably, the compartment 16A for housing the dressing cup will contain a circular U-shape with a straight edge on one side. The dressing compartment 16A can also contain a peripheral flange, such as a shelf or ledge, that surrounds the opening of the compartment 16A to support an outer rim of the dressing cup to allow it to rest on the shelf of the compartment 16A without contacting the lower level of the recessed dressing compartment 16A, opposite the opening, so that the dressing cup does not rest on the floor of the compartment 16A. This shelf can keep the upper part of the dressing cup near the opening of its compartment so it is easier to remove and so that it does not get stuck inside the bottom of the recess of the compartment 16A. Furthermore, at the straight edge of the dressing compartment 16A, the shelf surrounding the dressing compartment 16A opening extends horizontally past the compartment 16A and into the flat surface of the lid 10. This extension of the shelf can provide the user with an easy way to grasp the outer rim of the dressing cup and to remove it from the compartment 16A.

The remaining compartments 16 may be any shape and size since typically the food ingredient may be stored directly in the cavity of the compartment 16 and thus can conform to the shape of the cavity. Preferably, one of the three remaining compartments 16 can be larger in size than the other two, with the remaining two compartments 16 being similar in shape and size to each other.

Furthermore, at least one of the base and lid is transparent and each can be semi-rigid or rigid and has been shaped or is shaped in-line, such as by suitable forming or heat molding techniques, into the shapes illustrated in the drawings or other suitable shapes. The terms “rigid” and “semi-rigid” are used herein to indicate that the structures made of these films have the ability to generally retain their respective shapes during normal handling.

It is preferable to initially keep packaged produce in an environment containing from about 0 to about 8% oxygen, and preferably about 0 to about 5%, and still more preferably from about 2 to about 5% oxygen, since less than 1% oxygen can cause the produce to start to degrade and to develop odors and undesirable flavors due to insufficient oxygen for respiration. Therefore, the produce in the base 24 can be initially packaged using MAP operations (modified atmosphere packaging) where a nitrogen flush can be provided to aid in preserving the produce, and to provide an initial oxygen level of about 0 to 8% oxygen, and preferably from about 0% to about 5%. The produce uses the oxygen to convert it into carbon dioxide over time. Therefore, the oxygen level in a packaged produce product is depleted over time and must be replenished. This can be done by allowing oxygen to permeate through the oxygen permeable film 28.

The barrier film layer 14 may be placed over the lid compartments 16 and 16A in an effort to prevent oxygen from passing through the film 14 and into the food-containing compartments. The food that is packaged in the lid 10, such as meat, can comprise oxygen sensitive ingredients which can spoil and/or reduce the shelf-life faster if packaged in an environment containing more than about 1% oxygen. Therefore, the food ingredients packaged in the lid 10 may require low oxygen levels to maintain the food's freshness and to preserve shelf-stability. Carbon dioxide in the gas flush stage of the MAP operation can also be used in addition to nitrogen gas to help extend the shelf-life of these oxygen sensitive, high moisture food ingredients. The lid 10 can be sealed and flushed separately from the base 24 using a combination of nitrogen and carbon dioxide gases, since the base 24 only requires a nitrogen gas flush (a carbon dioxide flush can be detrimental to the flavor quality of produce in the base 24).

Typically, the base 24 will house a produce ingredient such as romaine lettuce, iceberg lettuce, frise lettuce, greenleaf lettuce, radicchio, spinach, carrots, tomatoes, broccoli, cauliflower, peas, celery, onions, green onions, peppers, cucumber, potatoes, beets, sprouts, zucchini, squash and any combination thereof and other optional ingredients such as fruits, rice, or pasta. Optionally, the base 24 may further contain an eating utensil, such as a plastic fork, to be used when eating the produce meal. The base 24 may also optionally contain seasoning packets or pouches to be directly added to the produce or to first mix with a dressing.

Typical food ingredients in the lid compartments 16 and 16A may comprise protein sources like meat or cheese, and salad condiments such as croutons, fruit, vegetables, seeds, noodles, olives, tortilla strips, onion, and at least a dressing. The food ingredients may be placed directly into the cavity of the compartment 16 or, as in the case of a dressing, may be first placed in a cup or small container and then placed in the cavity of the compartment 16A. Possible meat products may include bacon or chicken, for example, with the chicken comprising various seasoned flavors. Possible cheese toppings may comprise Swiss, cheddar, parmesan, and other cheese varieties commonly used on salads. Other additional toppings may include fruits, tortilla strips, fried onions, nuts, noodles, croutons and any combinations thereof. Any type of dressing may be used with the salad and may be packaged in a dressing cup, such as Caesar, sesame-ginger, ranch, salsa-ranch, honey-Dijon, and other similar varieties.

Additionally, ingredients that may be in either the lid or the base may include fruits, such as apples, grapes, oranges, grapefruits, melon, peaches, pineapple, berries, and other similar fruits, and pasta, rice, tortillas, pita, bread, cookies, chocolate, crackers, eggs, peanut butter, hummus, sauces, dips, spreads, and soups by way of example.

To open the container 30, the consumer may grasp the corner tabs 40 and 42 and can apply a force to each in opposite directions in order to pull the lid 10 and base 24 apart. Once the lid 10 and base 24 are separated, their respective film layers 14 and 28 can be removed. Again, the consumer can grasp a loose edge of the film that overlaps at the corner tabs 40 and 48 and pull the film up to release it from its respective component section. Once the base 24 is opened by removing its film 28, the produce therein is exposed and ready to be eaten or to be prepared for eating by adding the additional ingredients contained in the lid 10. Any optionally placed items therein may also be removed. For example, an eating utensil, such as a fork, may be located therein and can be removed before adding additional food ingredients. Likewise, an ingredient packet or pouch may be contained therein for mixing with the dressing or to open and sprinkle over the produce contained in the base 24.

Once the lid component 10 is opened by removing its film 14, the multiple compartments are exposed. For example, there may be four total compartments 16 and 16A, where at least one contains a dressing cup, and the remaining three contain food ingredients. The dressing cup located in the dressing compartment 16A may be removed first and set aside. The remaining food ingredients can then be added to the salad in the base 24. The remaining food ingredients can either first be removed from their respective compartments in the lid 10 and then later added to the produce in the base 24, or the lid 10 can be flipped over the opening 38 in the base 24 such that the food ingredients fall inside, or any other removal means can be used. If the consumer wishes, the dressing cup can then be opened and added to the produce and food ingredients in the base 24 to create a salad. Optionally, the lid 10 can be snapped back into place over the base 24 and the contents can be shaken to distribute the dressing equally within the salad. Still optionally, the lid 10 can be snapped back into place over the base 24 to reclose the container and save an uneaten portion for later use.

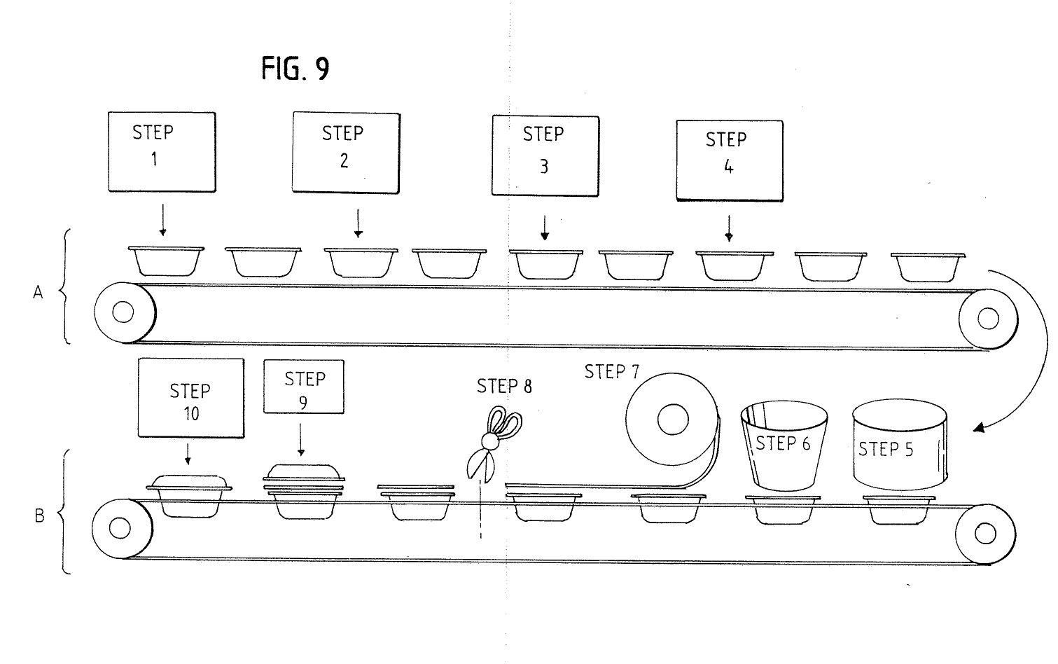

Turning to the method of manufacture, as illustrated in FIG. 9, a schematic of the process line is shown. The base section and the lid section can be packaged separately and later combined. The base section can be packaged in two phases; addition of ingredients can occur along a general conveyor, shown at segment A, and the base can then be sealed and packaged in a modified atmosphere, shown at segment B. At step 1, along the general conveyor A, the bowls can be placed on the conveyor line. Produce can then be added to the bowls at step 2, where the produce can be cleaned and cut prior to filling the bowls. Pre-blended vegetables may optionally be added as well. At step 3, cleaned and cut fresh vegetables and/or fruits may optionally be added to the produce. An ingredient pouch or tray may also optionally be added to the bowl, at step 4. The filled bowls can then be transferred to the second conveyor belt B, comprising modified atmosphere packaging equipment.

At step 5, a vacuum flush can be used followed by a carbon dioxide and nitrogen gas flush, at step 6. Step 7 comprises a web of oxygen permeable film that can be placed over the bowl of food to seal the bowl, and can be subsequently cut at step 8. At step 9, the filled and sealed multi-component lid can be attached to the sealed bowl and labels can be added at step 10. Both the base and lid may be made out of any suitable component and preferably may be made from a clear plastic material.

From the foregoing, it will be appreciated a multi-component produce container for control of gas permeation is provided that allows for packaging different food components separately in one container, and methods of manufacture thereof. However, the disclosure is not limited to the aspects and embodiments described hereinabove, or to any particular embodiments. Various modifications to the multi-component produce container and methods of manufacture can result in substantially the same container and methods of manufacture.

What is claimed is:

1. A multi-component container comprising:
a base having a compartment for storing produce and a peripheral flange;
an oxygen permeable film covering an opening of the base and sealed to the peripheral flange;
a lid having a peripheral rim for engaging the flange of the base to close the opening of the base, the lid being spaced from the oxygen permeable film by an air cavity; and
a vent in the rim of the lid permitting gas to pass the engaged rim and flange and enter the air cavity.

2. The container of claim 1, wherein the lid comprises at least two recessed compartments surrounded by sealing surfaces for storing food ingredients therein and a barrier film is sealed to the sealing surfaces to cover each of the compartments, and the air cavity is between the barrier film and the permeable film.

3. The container of claim 1, wherein the vent permits oxygen to pass therethrough to the air cavity and through the oxygen permeable film into the base.

4. The container of claim 3, wherein the vent extends in two different directions at right angles to each other and has a width that is at least about 1 mm.

5. The container of claim 1, wherein the rim of the lid fits over the flange of the base, the rim of the lid being located along a perimeter of the lid and the flange of the base being located around a perimeter of the base and shaped to receive the rim of the lid.

6. The container of claim 5, wherein the rim of the lid has a radially outwardly extending segment and a depending segment, and wherein both segments contact the flange of the base and are generally flush with the flange.

7. The container of claim 6, wherein a portion of the vent is positioned in the radially outwardly extending segment and a portion is positioned in the depending segment of the rim, such that the vent permits passage of oxygen between the flange of the base and the rim of the lid and ultimately into the air cavity between the base and the lid.

8. The container of claim 1, wherein the base and the lid are both packaged under negative pressure and the oxygen level is initially brought down to about 0% to about 8% in the base, and wherein the produce food product maintains an oxygen level in the base between about 0% and about 5% after being packaged.

9. The container of claim 2, wherein separation of the assembled base and the lid is minimized or eliminated at altitudes in excess of about 8,000 feet and the film layers placed over each do not leak while at altitudes in excess of about 12,000 feet.

10. The container of claim 1, wherein the base contains produce food products that are selected from the group consisting of romaine lettuce, iceberg lettuce, frise lettuce, greenleaf lettuce, radicchio, spinach, carrots, tomatoes, broccoli, cauliflower, peas, celery, onions, green onions, peppers, cucumber, potatoes, beets, sprouts, zucchini, squash and any combination thereof.

11. The container of claim 10, wherein the base may further contain an eating utensil.

12. The container of claim 2, wherein the lid contains at least a dressing cup and a food ingredient.

13. The container of claim 12, wherein the dressing cup is stored in a dressing compartment in the lid generally shaped to compliment a shape of the dressing cup.

14. The container of claim 13, wherein the dressing compartment for storing the dressing cup has a depth greater than a depth of the dressing cup, wherein the dressing compartment contains a peripheral flange to support a rim of the dressing cup and the dressing cup does not rest on the floor of the dressing compartment.

15. The container of claim 2, wherein the lid further contains food ingredients selected from the group consisting of cheese, meat, croutons, fruit, vegetables, seeds, noodles, tortilla strips, onion, and any combination thereof.

16. The container of claim 1, wherein an outer label is wrapped around the base and lid in the assembled configuration.

17. The container of claim 1, wherein the barrier film is selected from the group consisting of polyester, ethyl vinyl alcohol, and polypropylene.

18. The container of claim 1, wherein the oxygen permeable film is selected from the group consisting of polypropylene and polyethylene.

19. A method of providing oxygen to a sealed container filled with produce comprising:
sealing an opening of a base containing produce with an oxygen permeable film using modified atmosphere packaging having a nitrogen gas flush;
sealing a lid containing food ingredients with a barrier film using modified atmosphere packaging having a nitrogen and carbon dioxide gas flush, and placing the lid over the oxygen permeable film of the base and being spaced from the oxygen permeable film by an air cavity; and
providing air channels in an edge of the lid to permit oxygen to migrate between the edge of the lid and an edge of the base and to permeate into the air cavity between the base and lid.

20. A multi-component produce container containing food comprising:
a base having a compartment for storing produce and a peripheral flange;
an oxygen permeable film placed over an opening of the base;
a lid having a peripheral rim for engaging the flange of the base to close the opening of the base, the lid being spaced from the oxygen permeable film by an air cavity;
a plurality of recessed compartments in the lid for storing food ingredients therein;
a barrier film sealed over the recessed compartments in the lid; and
a plurality of air channels positioned in the rim of the lid permitting gas to pass through the air channels and into the air cavity.
